(19) United States
(12) Patent Application Publication
(10) Pub. No.: US 2009/0199518 A1
(43) Pub. Date: Aug. 13, 2009

(54) MEANS FOR PENETRATING A PORTION PACKAGING CONTAINING AN EXTRACTION PRODUCT, DEVICE FOR EXTRACTING THE EXTRACTION PRODUCT CONTAINED IN THE PORTION PACKAGING, AND METHOD FOR PRODUCING THE MEANS

(76) Inventors: Louis Deuber, Richterswil (CH); Peter Herren, Bellmund (CH); Kees Aardenburg, Lugano (CH)

Correspondence Address: THE NATH LAW GROUP, 112 South West Street, Alexandria, VA, 22314, US

(21) Appl. No.: 12/310,400

(22) PCT Filed: Aug. 24, 2007
(86) PCT No.: PCT/EP2007/058812

§ 371 Date: Feb. 24, 2009

(30) Foreign Application Priority Data
Aug. 25, 2006 (EP) 06119565.7

(51) Int. Cl. B65B 43/26; A47J 31/44

(52) U.S. Cl. 53/492; 99/300

(57) ABSTRACT

Disclosed is a means for penetrating portion packaging, especially a capsule (2), which contains and extractable material. Said means comprises perforation elements (7, 8) that are provided with a plurality of openings (9) and allow a shell of the capsule (2) to be pierced. The openings (9) are disposed in such a way on a lead-through surface which extends at an angle to the direction of perforation that the openings (9) form a punched screen structure. The perforation elements (7, 8) are embodied as a member that has several faces, one of which is a lead-through surface. Preferably, the lead-through surface on the extraction side is formed by a foil section that is provided with the openings (9).

The invention relates to a means for penetrating a portion packaging containing an extraction product according to the precharacterizing clause of claim 1. Furthermore, the invention relates to a device for extracting an extraction product contained in a portion packaging according to claim 37. The invention then relates to a method for producing means for penetrating a portion packaging containing an extraction product according to claim 40. Devices of this type are used in particular to provide beverages, such as, for example, coffee, tea or cocoa, the extraction product preferably being enclosed as a dry substance in a casing of the portion packaging. Portion packagings of this type may be capsules into which the extraction product is hermetically sealed. However, the field of use is not restricted to capsules of this type. For example, what are referred to as “sachets” or “pouches” could also be used together with a paper filter as the encasement.

For example, EP 1 295 554 A1 has disclosed an extraction device for capsules, in which a capsule is pierced by penetration means during closure of the cavity. In EP 1 295 554 A1, a generically comparable means for penetrating the capsule is shown on the bottom of the cavity of the capsule holder. This means has a multiplicity of perforation elements which are designed as needles and are arranged on the entire surface of the means. The penetration element itself is of conical design. Three longitudinal slots are arranged on the circumferential surface of the cone, as a result of which coffee as the extract can be conducted out of the capsule. In practice, it has turned out that the penetration means can be difficult to produce.

U.S. Pat. No. 3,596,588 shows a device in which an individual spike constructed in the shape of a pyramid serves as the injector. A respective opening for passing heated water into a portion-sized coffee container is arranged on the end surfaces of the pyramid. To penetrate the bottom of the container, spikes having openings of elongated design are provided. The flow of coffee product into the container can be implemented only to an inadequate extent using these means. With the injector, the water is not uniformly distributed into the container. On the opposite side, i.e. on the extraction side, there is the problem that an undesirable overflowing of coffee grounds out of the can through the slots is possible. In addition to production being difficult, the penetration means have the disadvantage that they are not very suitable for plastic capsules.

DE 74 30 910 U shows an extraction device for containers made of aluminium sheet. The device has a single piercing spike which first of all penetrates an upper side and then the opposite lower side of the container. For the perforation operation, a point which is adjoined by a cylindrical circumferential surface of a simple or stepped hollow cylinder is arranged at the front end of the piercing spike. A multiplicity of openings are arranged on the circumferential surface or the circumferential surfaces of the hollow cylinder. In this case, the piercing spike is introduced into the container in such a manner and to such an extent that, after the end of the penetration operation, the point is located outside the container and does not participate in the extraction operation. The hollow cylinder is blocked approximately centrally by a transverse wall which divides the interior into a hot-water feed part and a prepared-drink discharge part.

This arrangement results in a complex guidance of the fluid in order to extract the prepared drink. A further disadvantage which has-been shown in practice is that the sealing of the piercing spike by means of the proposed O-ring seal is difficult. There are further disadvantages in terms of manufacturing, since, for example, the provision of the openings on the circumferential surface is unfavourable.

It is therefore an object of the invention to provide a penetration means which is distinguished by improved passage through it. With the penetration means, a high-quality extraction product, for example coffee, tea or cocoa, is to be able to be produced. In addition, the penetration means is to be able to be produced simply and cost-effectively, and is to be capable, in particular on the extraction side, of carrying out an actual straining function. This object is achieved according to the invention with a means which has the features in claim 1.

Owing to the fact that the perforation element is designed as a multi-surface body, in particular a body in the manner of a polyhedron, wherein at least one of the surfaces is a surface which is inclined towards the perforation direction and on which openings are arranged preferably in a strainer structure, improved passing through of fluid in the portion packaging is produced. In particular, an advantageous filter action can be achieved.

In particular with regard to manufacturing, it may be advantageous if the surfaces on which openings are arranged in the strainer structure are planar or concavely curved surfaces. The openings can thereby be provided in a simple manner on the surfaces. However, the concave configuration of the surface may also be useable for effective penetration, since advantageous edges can be provided by the inwardly directed curvature.

The openings can each be round holes, with it being possible for the diameter of the round holes to be between 0.1 and 0.5 mm and preferably between 0.2 and 0.3 mm. With this opening configuration, high-quality extraction products, in particular coffee, can be produced.

It may be advantageous for the perforation element to be designed as a pyramid with a preferably triangular basic surface, with it being possible for at least one of the side surfaces of the pyramid to have openings in the strainer structure. As an alternative, the multi-surface body for the perforation element can be designed as a trimmed shaped body, in particular as a trimmed cone, a trimmed pyramid or a trimmed wedge, and a pass-through surface provided with openings in a strainer structure can be predetermined by the preferably sloping section.

With the strainer structure according to the invention, the passing of a fluid through the particular perforation element can be considerably improved. In this case, passing through can refer, on the one hand, to the introduction of a fluid into the portion packaging (injection) and, on the other hand, also to the conduction of a fluid out of the portion packaging (extraction). If the means is used for injecting a fluid, the fluid can be, for example, hot water. The fluid on the conducting-out side could then be the extracted coffee. A penetration means could have, for example, integrally formed, assembled or otherwise multi-part perforation elements. The strainer structure could also afford advantages in combination with conventional means for penetrating a portion packaging.

A configuration as a multi-surface body is not absolutely necessary in order to achieve advantageous pass-through results.

It may be advantageous if the openings are configured as a round hole. Of course, however, other hole shapes would also be conceivable. For example, an elongated hole or a hole with a rectangular shape (in particular, for example, square) are suitable.

It is particularly advantageous if the strainer structure has at least four, preferably, however, at least ten openings. By means of such a multiplicity of openings per perforation element, the throughflow quantity can be increased, with, in the case of the injection, optimum dispersion and, on the extraction side or in the outlet region, an advantageous filtering effect being ensured.

The strainer structure can be a perforated area with openings arranged in rows. The perforated area may comprise, for example, straight rows or offset rows. In the latter case, it may be advantageous if the rows are offset diagonally (offset by 45°) or if the openings are arranged in rows offset by 60°.

It may be advantageous if the strainer structure is designed in such a manner that the web width is smaller than the hole width of the openings. In this case, hole width is understood as meaning the smallest size for the hole opening, for example in the case of a round hole, the diameter thereof. The web width is the smallest unperforated intermediate space between two adjacent openings (or holes). It may be particularly advantageous if the relative free perforated surface is smaller than 0.3. These characteristic numbers of a strainer structure are known to and are customary for a person skilled in the art.

According to a second aspect of the invention, a means for penetrating a portion packaging containing an extraction product can contain at least one perforation element with which a casing of the portion packaging can be pierced, said perforation element being at least partially composed of a sheet-like material, in particular a foil or a thin metal sheet. The at least one perforation element can be fastened to a preferably disc-shaped basic component. By means of the use of sheet-like material for the perforation element, the production of the penetration means can be considerably simplified. Depending on the intended use, it is even conceivable to provide perforation elements without openings for the passing through of fluid. In this case, the fluid could be conducted through one or more openings in the basic component.

It may be advantageous if the perforation element is formed from at least one blank which is raised from a sheet-like position into an end position, with the raised blank in the end position entirely or partially predetermining the shape of the perforation element. A blank can be processed in a simple manner. The use of a blank has the advantage, inter alia, that openings can be made thereon in a simple manner.

It may be particularly advantageous if the perforation element is formed from a single blank. This configuration in particular has the advantage that only a few connections, for example welded joints, are necessary in order to stabilize the raised blank in the end position.

The raised blank can be stabilized in the end position by means of a welded joint. One or more weld seams or individual spot welds can be provided for the welded joint.

In a further embodiment, the perforation element can contain at least two abutting surface sections which form a common side edge, with the surface sections being folded over around the side edge. In this case, in order to predetermine the side edge in the blank, there is a line of weakness, in particular a line of weakness with section line portions which extend to a limited extent in the direction of the line of weakness and about which the surface sections can be folded over. A defined folding-over operation can thereby be ensured.

Furthermore, it may be advantageous if the blank has at least three, in each case triangular surface sections, the blank, by folding over of the surface sections, being raisable from the sheet-like position in such a manner that a pyramid-like hollow body is present in the end position.

The perforation can be furthermore improved if the perforation element has two surface sections lying on each other, with one of the surface sections being offset inwards in relation to a border of the other surface section in order to form a cutting edge. In this case, the two surface sections lying on each other can be welded to each other by a fillet weld.

The perforation element can be welded to the basic component. Of course, other fastening means, such as glued joints, are also conceivable.

At least one opening through which a fluid can be passed can be arranged on at least one of the surface sections of the perforation element, preferably on each surface section. Depending on whether the penetration means is used on the injection side or extraction side, just one larger opening or a plurality of smaller openings can be arranged on the at least one surface section, in particular openings in a strainer structure on the surface section.

A third aspect of the invention relates to a configuration of the penetration means in which the perforation element has a basic body by means of which the shape of the perforation element is entirely or partially predetermined and in which at least one surface section is fastened to the basic body. In particular, a considerable reduction in the production outlay can be achieved as a result. The at least one opening of the pass-through surface can be provided in a simple manner, for example on a surface section lying in a plane. After the opening is provided, the surface section can be fastened to the basic body, for example by gluing or welding. Since the foil section is designed as a separate component with respect to the basic body, different materials and/or different material thicknesses can be used for the foil section. A pass-through surface within the meaning of the invention is understood as meaning a surface of the perforation element which is provided with at least one opening through which a fluid can be passed. Of course, a surface of the basic body can also form such a pass-through surface. As an alternative, it would even be conceivable that the surface section does not have an opening and, instead, the at least one pass-through surface would be assigned to the basic body.

Of course, it may also be advantageous for the second or third aspect if a plurality of openings are provided for each pass-through surface and if the openings—as previously described—form a strainer structure.

The perforation element may also be designed for the third aspect of the invention as a multi-surface body, with one of the surfaces being a pass-through surface on which an opening or a plurality of openings are arranged. An efficient perforation element can thereby be provided. The multi-surface body may have at least one side surface and a pass-through surface, that is to say, therefore at least two surfaces. A two-surface body could be—of course without including a base surface—for example a cone cut in a sloping manner, in which case the side surface would be the circumferential surface of the cone. A three-surface body could be, for example, a pyramid with a triangular base surface, in which case one of the side surfaces could form the pass-through surface. This embodiment has advantages especially in terms of production. The openings can thus be provided on the pass-through surface in a relatively simple manner. Use can be made for this of, for example, a drilling process using a laser. However, this arrangement also has a positive effect on the pass-through properties of the perforation element. It has surprisingly turned out in this embodiment that the openings on the pass-through surface do not absolutely have to have a strainer structure. The abovementioned advantages may also be achieved by different arrangements of openings.

The multi-surface body for the perforation element may be a trimmed shaped body, with it being possible for the pass-through surface to be predetermined by a preferably sloping section. This produces an advantageous asymmetrical design of the point. Even without an exact shape of the point, the perforation element is reliably capable of perforating the capsule foil, another packaging foil or the like. Examples of suitable shaped bodies are cones, pyramids or wedges. Therefore, a body for the perforation element could be a cone cut in a sloping (or oblique) manner. Of course, it would also be conceivable in principle to provide a rectilinear section. In this case, the corresponding body would be a truncated cone. If the basic body forms the trimmed shaped body, it may be advantageous, for example, if the surface section with the pass-through surface is fastened to the basic body in the region of the cut surface produced by the Cutting of the shaped body. Such a shaping could also be advantageous for other penetration means.

In a further embodiment, the pass-through surface may be a wedge surface which is preferably directed towards the centre of the means. In the case of a preferably rotationally symmetrical means, this centre can be defined by the axis of said surface.

In a further embodiment, the at least one surface section can have a side border which bears against the basic body. If the basic body is of sheet-like design, for example if it is formed by a single basic body surface, it may be advantageous if the side border bears against said basic body surface. However, it would, of course, also be conceivable that the surface section bears against the basic body in such a manner that a common edge is formed.

It may furthermore be advantageous if the basic body is of sheet-like design and if at least two surface sections are fastened to the basic body, with it being possible for the basic body and the surface sections to form a multi-surface body. In this case, at least one of the surface sections and if appropriate the basic body can each have the pass-through surface with at least one opening in each case. It is therefore in particular not absolutely necessary to assign the pass-through surfaces just to the surface section. The basic body can also have at least one pass-through surface. As a result of the fact that the perforation element is designed as a multi-surface body comprising the basic body and the surface sections, relatively complex three-dimensional structures can also be produced in a simple manner. Openings can be introduced into the respective surfaces in a simple manner, for example by means of laser drilling or etching processes.

If the basic body is of sheet-like design and two surface sections are provided, it may be advantageous if the basic body and the surface sections are each of triangular design and if the assembly comprising basic body and the surface sections has a pyramid-like configuration. In this case, the two surface sections can be designed as components which are separate from each other or if need be can also be of integral design.

It may be advantageous if at least one surface section and the basic body are offset with respect to each other in such a manner that a cutting edge is formed by the offsetting. By means of such a cutting edge, even portion packaging casings which are relatively difficult to perforate can be perforated in a simple manner. For example, by means of such cutting edges, polypropylene capsules can be readily perforated even when cold.

It may be particularly advantageous if at least one surface section is offset inwards in relation to a border of the basic body in order to form a cutting edge. Of course, it would also be conceivable that, for example, a sheet-like basic body could be offset inwards in relation to a border of the surface section in order to form a cutting edge.

The perforation can be further optimized if a blade element for cutting through the casing of the perforation packaging for the first time in order to initiate the piercing operation is attached to the basic body and/or to at least one surface section. The blade element may be composed of hardened steel. Blade elements of this type could be configured, for example, in the manner of shaving blades.

A basic component of the perforation element can be formed from a sheet-like, preferably disc-shaped blank, with the basic body being separated or being able to be separated from the blank in a sheet-like position by cutting lines, and the basic body being raised from the sheet-like position into an end position. Such a basic component with raised basic bodies can be produced in a simple manner, for example from thin steel sheets. The cutting lines can be provided by laser cutting or by punching operations. The raising operation can be achieved in a simple manner by bending the cut-out basic body out of the sheet-like position into the end position. For a defined raising operation, it may be advantageous if the blank is provided with a line of weakness, in particular a line of weakness which connects the ends of the cutting line, with the raised basic body being folded over around the line of weakness in the end position. Said line of weakness can be formed by at least one limited cutting-line portion.

The basic body and the at least one surface section can be composed of metal, in particular of steel. The surface section can be fastened to the basic body and/or to the basic component by a welded joint. A continuous seam or at least one spot-shaped welded joint is suitable as the welded joint. Of course, however, other types of fastening are also conceivable.

The perforation element, in particular the basic body of the perforation element, may advantageously have at least one side surface that is directed at an acute angle in the perforation direction. It may be advantageous in this case if the angle of inclination of inclined side surfaces of this type with respect to the perforation direction is smaller than 15°, preferably between 3° and 10° and particularly preferably approximately 5°. With such side surfaces tapering acutely in the perforation direction, the casing of the portion packaging can be perforated in a simple manner. Particularly good perforation results can be obtained if the surface sections and the basic body are directed at an acute angle in the perforation direction.

It has turned out in certain cases that the angle of inclination of the pass-through surface with respect to the perforation direction is advantageously greater than the angle of inclination of the side surfaces. In the case of curved pass-through surfaces, the surface normal through the surface centre point could also be used, of course, to determine the angle of inclination. Such an arrangement has both advantages in terms of production and a positive effect on the pass-through properties. In this case, the angle of inclination of the pass-through surface with respect to the perforation direction may preferably be greater than 15°. In particular if the means is used as an injector, the angle of inclination of the pass-through surface may be between 20° and 70°, particularly preferably between 25° and 50°.

In a preferred embodiment, the means has a plurality of perforation elements. Depending on the size of the portion packaging, the means has at least three perforation elements. For the known capsules, the number of perforation elements may be between 8 and 12.

The perforation elements may be arranged preferably distributed uniformly or at regular distances on a circle. In this case, the centre of the circle is advantageously predetermined by the centre of the means. It would furthermore be conceivable to arrange the perforation elements on a plurality of concentric circles.

The pass-through surface, in particular the pass-through surface of the surface section, may be a flat-surface. In certain cases, it has turned out that it may be advantageous if the pass-through surface is curved concavely. Of course, however, a convex curvature would also be conceivable.

In a special embodiment, the pass-through surface with the at least one opening and in particular with the openings in a strainer structure, in particular a pass-through surface of the foil section, and/or a side surface of the basic body may have a profile in which it is curved inwards in the manner of a spherical cup or is curved cylindrically inwards. In the case of the cylinder, the cylinder axis advantageously runs at a right angle to the centre axis of the perforation element or at a right angle to the perforation direction. The concave curvature of the pass-through surface has the effect, in combination with the asymmetric arrangement, that, depending on the basic shape of the perforation element, a front cutting edge which drops steeply to a greater or lesser extent is always formed. For example, in the case of a conical shaped body, the radius of curvature of the pass-through surface may be (for example) 6 mm, with an overall height of the perforation element of 4 mm. However, these exemplary masses can be changed.

The perforation element may be a projection which protrudes with respect to an upper supporting side for supporting the portion packaging, with it being possible for the upper supporting side and the perforation element to be assigned to form an integral component. In the case of a disc-shaped means, the upper supporting side would be predetermined by an upper disc side.

The abovementioned component may be composed of a metal sheet, in particular a metal sheet of stainless steel.

A metal sheet of this type is distinguished by good machineability. The component could also be composed of a non-metallic material. Furthermore, it is conceivable not to produce the perforation means from a single component. For example, the perforation elements could be designed as separate parts.

The perforation element may be a hollow body preferably provided by a deforming process.

However, the shape of the perforation element could also be advantageous for a means which is produced in a primary forming process, in particular in an injection-moulding process and/or sintering process. The means could be produced here, for example, from a ceramic material. These materials have excellent resistance to wear and can be produced in a shaping step (ceramic injection moulding). The perforation elements known from the prior art mentioned are configured as exactly sharp-pointed bodies, such as cannot satisfactorily be produced in an injection-moulding process because the mouldability of the points has proven very difficult. This always results in the retention of a small radius which blunts the point and which, in an extreme situation, causes the foil material to slightly expand but to not be perforated. Of course, in certain situations, the penetration means could also be produced from an injection moulding of plastic.

Particularly with regard to production, it may be particularly advantageous if the shape of the perforation element is predetermined by a basic body, and if the pass-through surface is formed by a foil section as the surface section which is provided with the openings and is fastened or can be fastened to the basic body. Such a two-part construction of the perforation element has the advantage that the openings can be provided in a simple manner on a foil of sheet-like configuration. A further advantage of the use of a foil is that the latter, owing to its flexibility, can simply be placed onto the basic body to fasten it thereto. Of course, the openings in the foil section could form a strainer structure. However, to achieve the advantages, the openings may also have a different arrangement of openings. It would even be conceivable just to provide one opening on the foil section.

The basic body may be, for example, a hollow body provided by a deforming or primary forming process.

If the basic body is an open hollow body, then it may be advantageous if the hollow body opening, which faces the perforation direction, is covered by the foil section. To fasten the foil section to the basic body, the foil section may have a border which is free from holes and which defines a contact surface with respect to the basic body.

The foil section may be composed of a foil of metal, preferably of a stainless steel.

The openings may be holes provided by a chemical etching operation or by laser drilling. This enables openings to be produced in a simple manner. A solution of this type also has advantages in terms of costs. Furthermore, holes with very small hole widths or with complicated hole shapes can be produced in a particularly simple manner by the chemical etching operation or by laser drilling.

The thickness of the foil may, in the case where the shape of the perforation element is predetermined by a basic body, advantageously be between 0.05 and 0.1 mm. Foils of this type are also known to the person skilled in the art as “microfoils”. Foils of this type: are suitable in particular for the abovementioned etching process. Of course, the holes could also be provided here, however, by means of laser drilling.

The surface section or the surface sections can be composed of a relatively thick foil or of a thin metal sheet, preferably from stainless steel. The thickness of said foil or of said sheet may be between 0.1 mm and 1 mm, advantageously between 0.15 mm and 0.6 mm and particularly advantageously between 0.2 and 0.4 mm. Surface sections comprising such foils or sheets are relatively stiff, as a result of which they can also be used by themselves for perforating. By contrast, the abovementioned microfilms are more suitable for use in penetration means in which the shape of the perforation element is predetermined by the basic body and in which the microfilm is hardly acted upon, if at all, by the casing of the portion packaging during the perforation operation.

It may be advantageous if the foil section is welded to the basic body. Of course, it would also be conceivable, however, to fasten the foil section to the basic body in another manner, for example by adhesive bonding.

If the means has a plurality of perforation elements, it may be advantageous if the foil sections assigned to the perforation elements are formed from a single foil blank. A foil blank of this type can be produced in a simple manner and is distinguished by easy handling. Of course, it would also be conceivable, however, to form the foil sections individually or separately.

If the means has a plurality of perforation elements, it may be advantageous if the plurality of basic bodies are formed integrally with a base plate. In this case, this base plate is preferably of disc-shaped design.

In a plan view, the foil blank may have a shape in the manner of a toothed wheel, the teeth of which are defined by the foil sections. A foil blank of this type is preferably suitable for a means in which the perforation elements have been arranged in a circle.

The means can furthermore have at least one central opening for additionally and/or alternatively conducting fluid into or out of a portion packaging perforated by the perforation elements. It can therefore be ensured that, should the openings of the pass-through surface(s) become clogged, passage through is nevertheless ensured. The abovementioned central opening therefore acts to a certain extent as an emergency input or emergency output for the fluid.

A basic component containing the at least one perforation element can be connected via a central clamping sleeve to a connecting part which can be fitted into an extraction device, with it being possible for the clamping sleeve to form the abovementioned central opening. The connection between the connecting part and the extraction device can be formed, for example, by a bayonet fastening or by other types of connection.

A further aspect of the invention relates to a device for extracting an extraction product contained in a portion packaging, in particular in a capsule, with an extractant. The device contains two chamber parts which can preferably be pressed against each other in a sealing manner to form an extraction chamber, one chamber part being designed as a capsule holder with a cavity for receiving the portion packaging and the other chamber part being designed as a closure part for closing the cavity. In this case, at least one of the chamber parts, preferably each chamber part (i.e. both the capsule holder and the closure part), contains the means described previously for penetrating the capsule and for passing the extractant through the closed extraction chamber, or the penetration element is assigned to at least one of the chamber parts. The use of means of this type makes it possible to prepare, for example, a coffee which meets exacting quality requirements.

At least one of the means can be screwed to the device. For this purpose, the disc body of the penetration means can have a central hole for the passage and receiving of a fastening screw.

In an advantageous embodiment of the device as a capsule module, the closure part can be designed as an injector for introducing the extractant into the capsule. In this case, the injector may be a means designed as an integral component. A filter plate for conducting the extract of the capsule may be arranged on the bottom of the cavity. This filter plate may be a means of two-part design in accordance with the filter construction previously described. A means of conducting away the abstract may be arranged in the capsule holder below the filter plate.

An annular receiving trough can be arranged on the bottom of the cavity, said receiving trough forming an annular gap between the filter plate and the bottom of the cavity. A receiving trough of this type is suitable in particular for penetration means in which the perforation elements are arranged on a circle.

The invention also relates to a method for producing means for penetrating a casing-like portion packaging containing an extraction product, in particular a capsule. The method is distinguished in that openings are provided on a surface section, in particular on a foil, by means of a chemical etching process or by laser drilling in order to provide a pass-through surface.

The openings may be etched into a foil section corresponding to the pass-through surface. The foil section may then be fastened by means of a welding process to a basic body which predetermines the shape of the perforation element for piercing a casing of the perforation packaging.

The basic body may be part of a base plate which can be formed by means of a metal injection moulding (MIM) process.

Of course, it would also be possible to provide openings directly—without the use of a separate foil—by means of a laser drilling process.

Furthermore, the invention is also directed at a capsule for use in a device described previously. The capsule is distinguished in that a set-back bottom section is arranged at least in that region of the capsule bottom which can be acted upon by the penetration elements. The bottom section may be designed in the manner of a trough in cross section. This bottom section may also be a channel which is designed as an inwardly directed depression encircling it annularly (“pre-brewing channel”). A channel of this type could be particularly advantageous, for example, in the case of use of a penetration means with a plurality of perforation elements, in which the perforation elements have been arranged in a circle.

The invention could furthermore relate to a method for extracting an extraction product contained in a portion packaging, in particular in a capsule, with a liquid extractant. In this case, the capsule may have a capsule bottom with a bottom section offset inwards with respect to the capsule bottom. A bottom section set back in such a manner could be, for example, the previously mentioned pre-brewing channel. In a first method step, two chamber parts are pressed against each other to form an extraction chamber. On the extraction side, the bottom of the capsule is only partially pierced by the perforation element during this pressing or closing operation. Before the pressure is applied, there may also be a distance between the capsule bottom and the upper supporting side. In the second method step, brewing water is introduced on the injection side into the capsule, as a result of which the capsule bottom, in particular the inwardly offset depression of the capsule bottom, is deformed against the upper supporting side, as a result of which the bottom of the capsule is completely pierced by the perforation element. A two-stage perforation operation of this type makes it possible to control the extraction method in an advantageous manner.

Further individual features and advantages of the invention emerge from the description below of exemplary embodiments and from the drawings, in which:

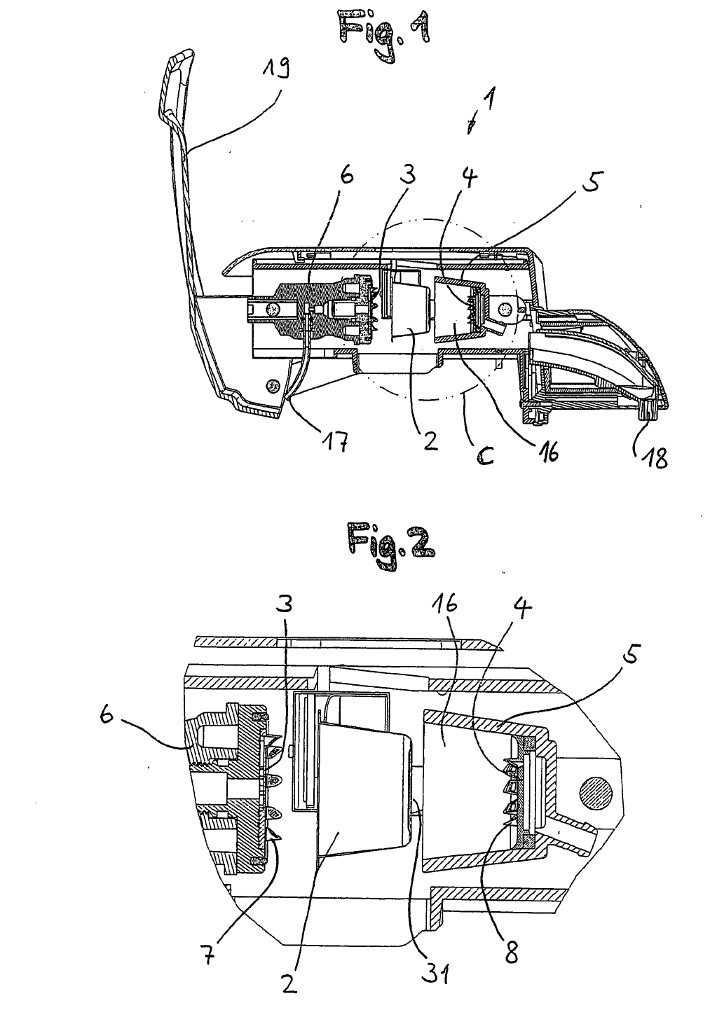

FIG. 1: shows a section through a device according to the invention for extracting an extraction product contained in a capsule,

FIG. 2: shows an enlarged illustration of the detail C from FIG. 1 with an injector plate and a filter plate as penetration means,

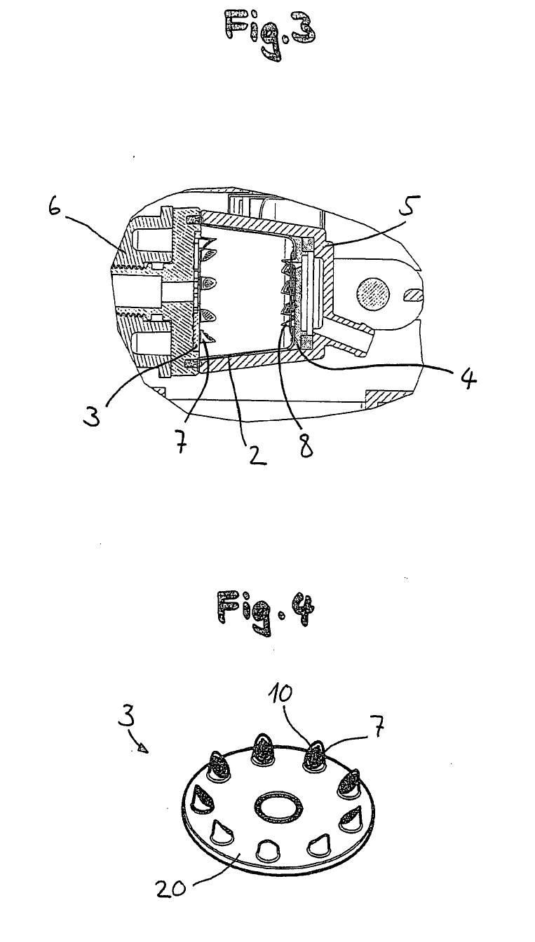

FIG. 3: shows the detailed view according to FIG. 2, but in the closed position,

FIG. 4: shows a perspective illustration of the injector plate of the device according to FIG. 1,

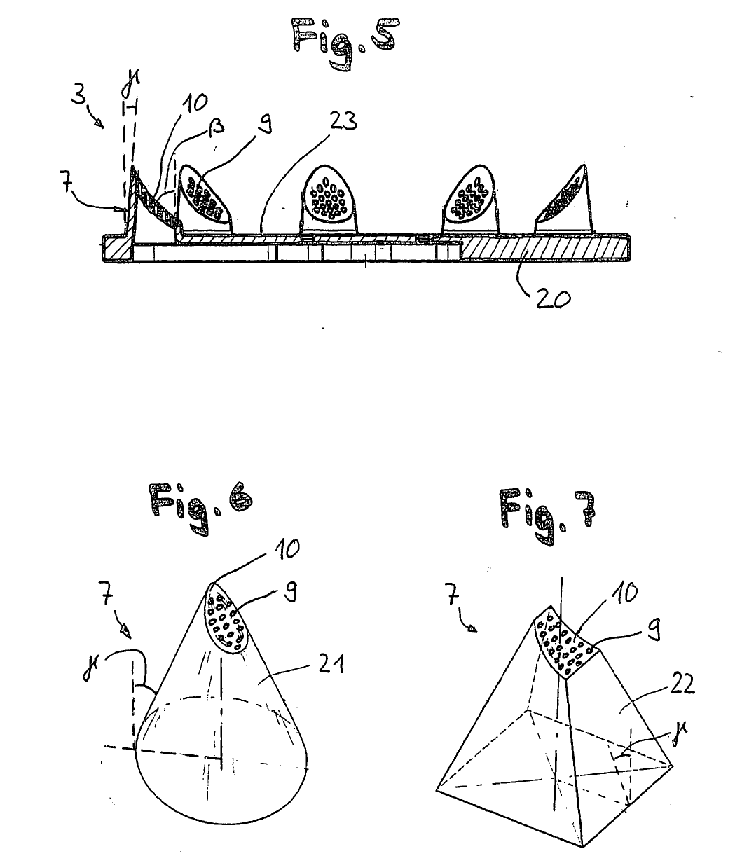

FIG. 5: shows a cross section through the injector plate according to FIG. 4,

FIG. 6: shows a perspective illustration of an alternative penetration element,

FIG. 7: shows a further alternative of a penetration element,

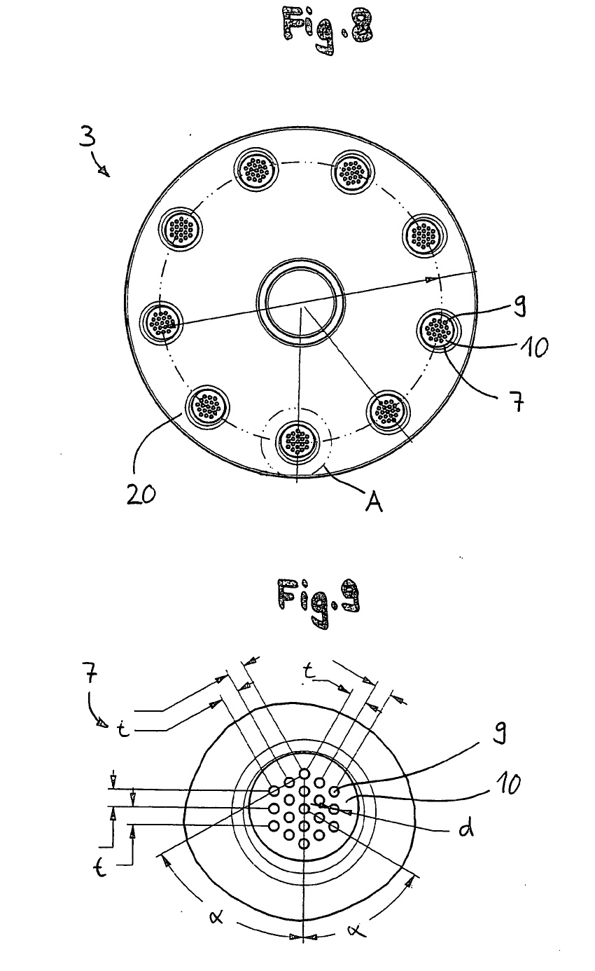

FIG. 8: shows a plan view of the injector plate according to FIG. 4,

FIG. 9: shows an enlarged illustration of a plan view of the perforation element of the injector plate according to FIG. 4 (detail A according to FIG. 8),

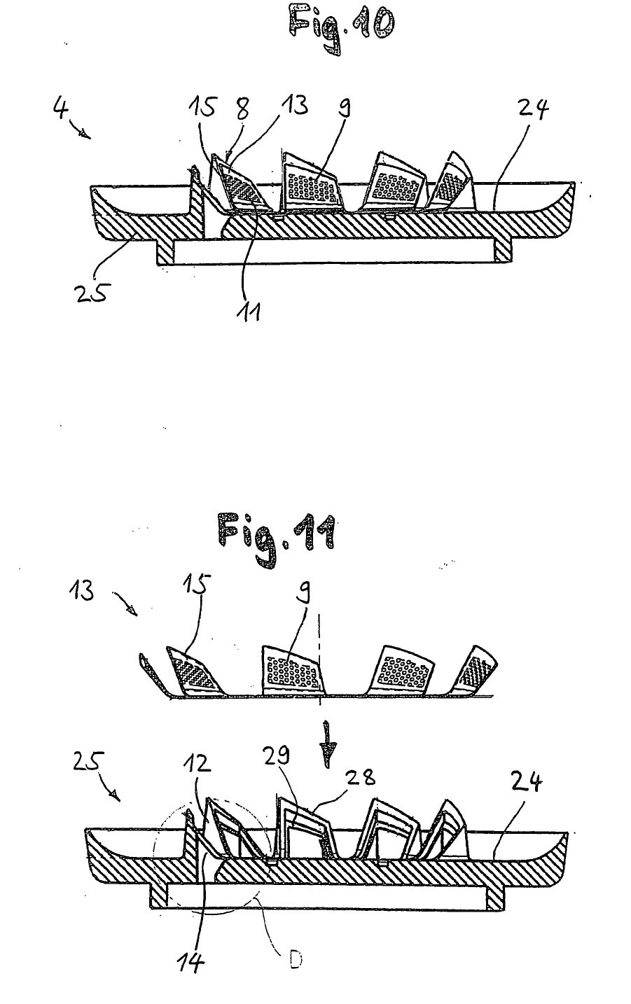

FIG. 10: shows a section through the filter plate of the device according to FIG. 1,

FIG. 11: shows a sectional illustration with a foil and a base plate for the filter plate according to FIG. 10 before the foil is fastened to the basic body,

FIG. 12: shows a perspective view of an upper side of the base plate according to FIG. 11,

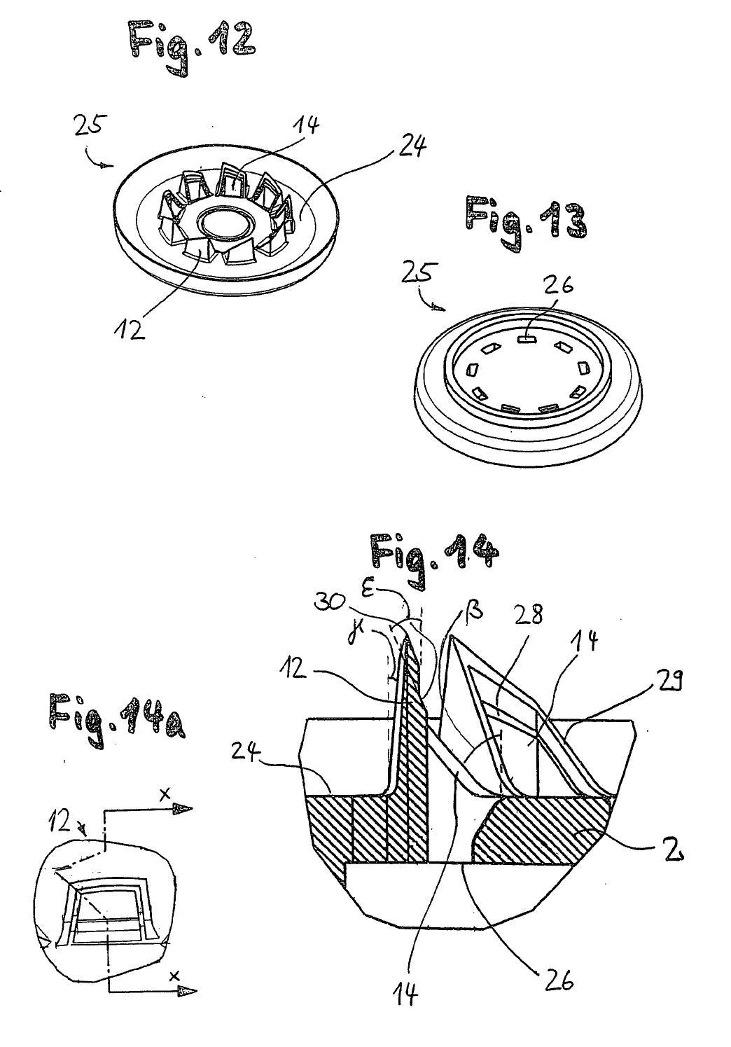

FIG. 13: shows a perspective view of a rear side of the base plate according to FIG. 11,

FIG. 14: shows a detailed illustration of the basic body (detail D according to FIG. 11, Section x-x according to FIG. 14a),

FIG. 14a: shows a front view of the basic body with the sectional profile x-x,

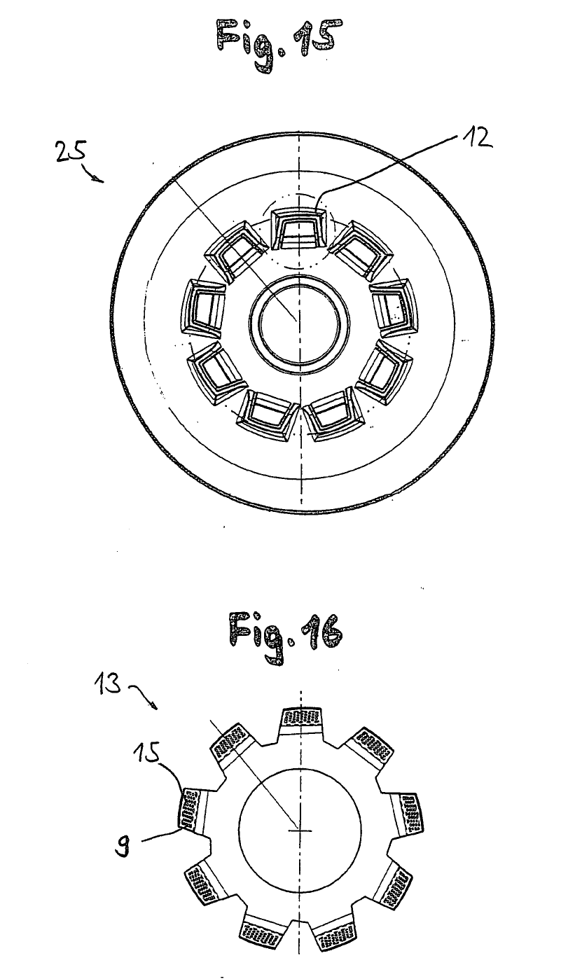

FIG. 15: shows a plan view of the base plate according to FIG. 11,

FIG. 16: shows a plan view of the foil according to FIG. 11,

FIG. 17: shows a perspective illustration of the foil (turned over),

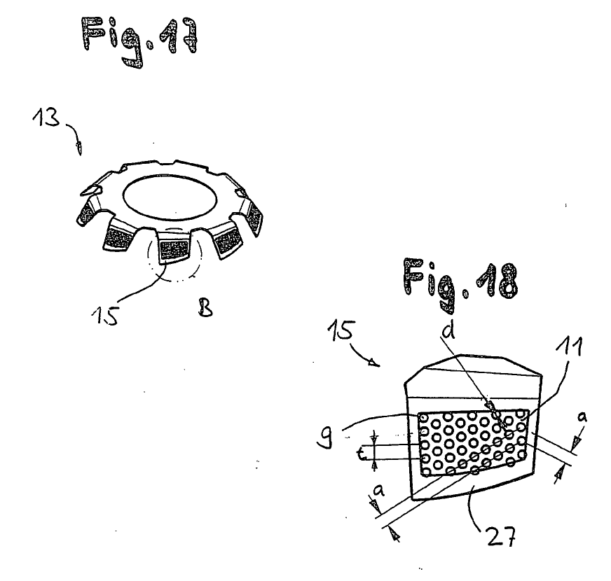

FIG. 18: shows a detailed illustration of a foil section of the foil according to FIG. 11 (detail B according to FIG. 17),

FIG. 19: shows a capsule for the device,

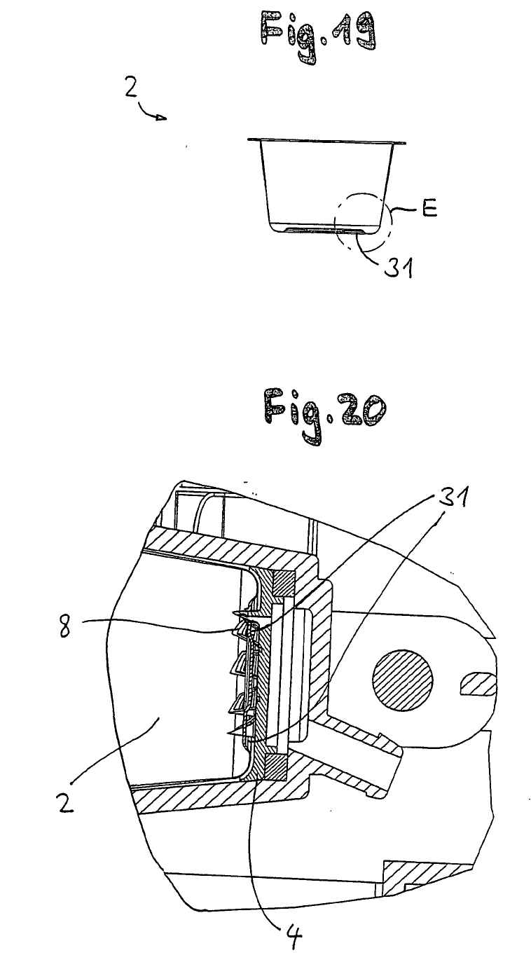

FIG. 20: shows an enlarged illustration of the extraction side of the device in the closed position with the capsule according to FIG. 19,

FIG. 21: shows a greatly enlarged illustration of the capsule with a pre-brewing channel (detail E according to FIG. 19),

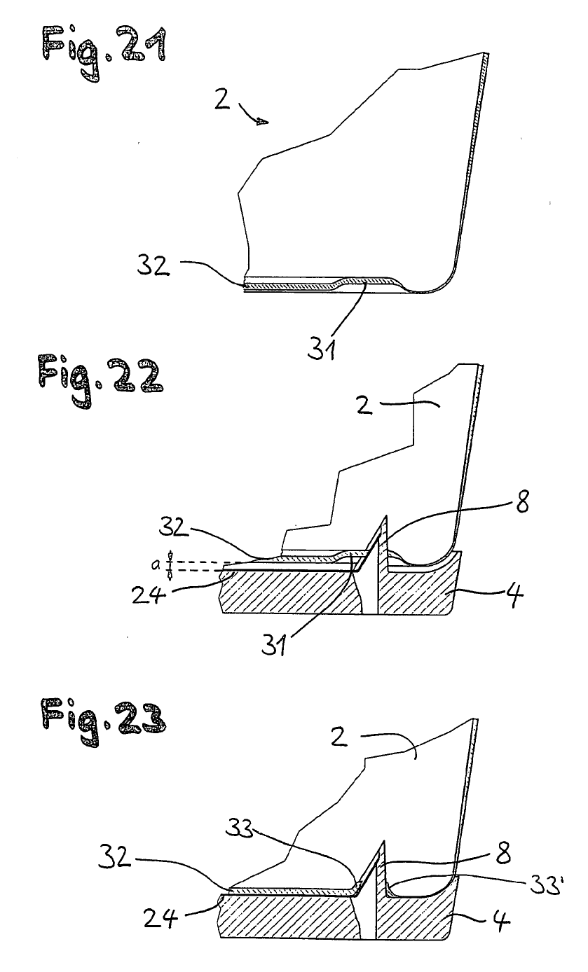

FIG. 22: shows the capsule according to FIG. 21 after the closing operation (closing position) with a perforation element partially piercing a capsule bottom,

FIG. 23: shows the capsule according to FIG. 21 after a brewing operation, in which the capsule bottom is completely pierced,

FIG. 24: shows a device with a capsule inserted therein according to an alternative exemplary embodiment to FIG. 1,

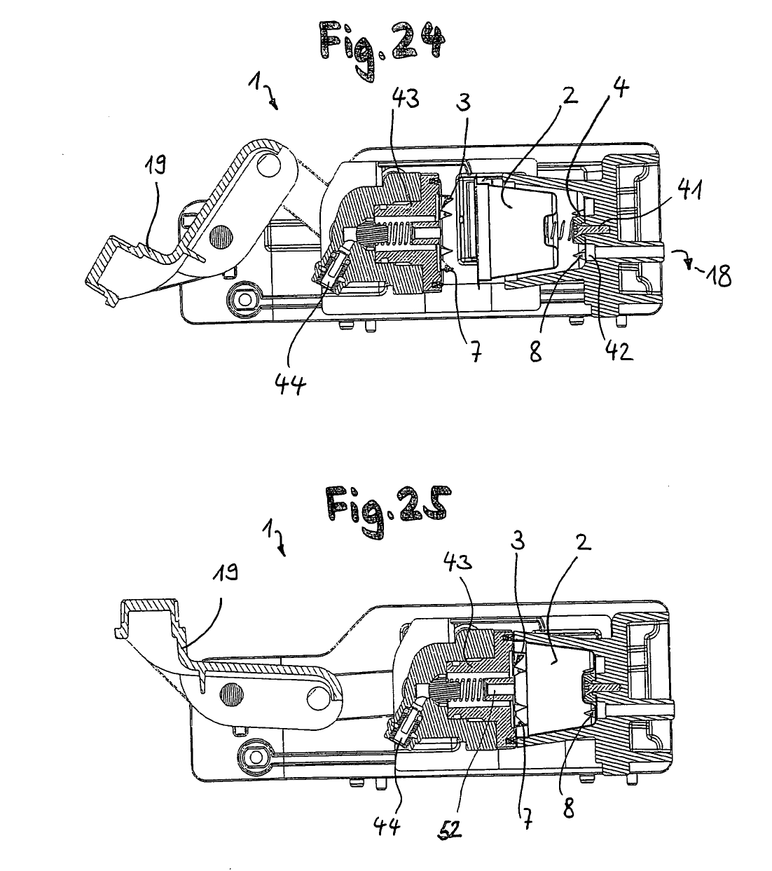

FIG. 25: shows the device according to FIG. 24 in the closed position,

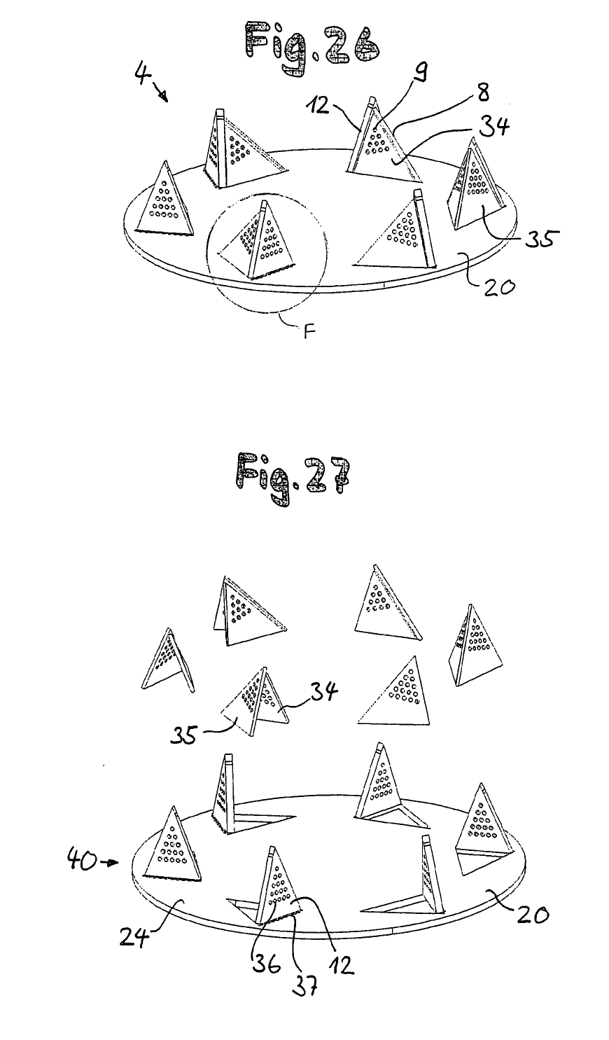

FIG. 26: shows a perspective illustration of a filter plate for the device according to FIG. 24,

FIG. 27: shows an exploded illustration of the injector plate according to FIG. 26,

FIG. 28: shows a side view of the injector plate,

FIG. 29: shows a basic component for the injector plate with raised basic bodies,

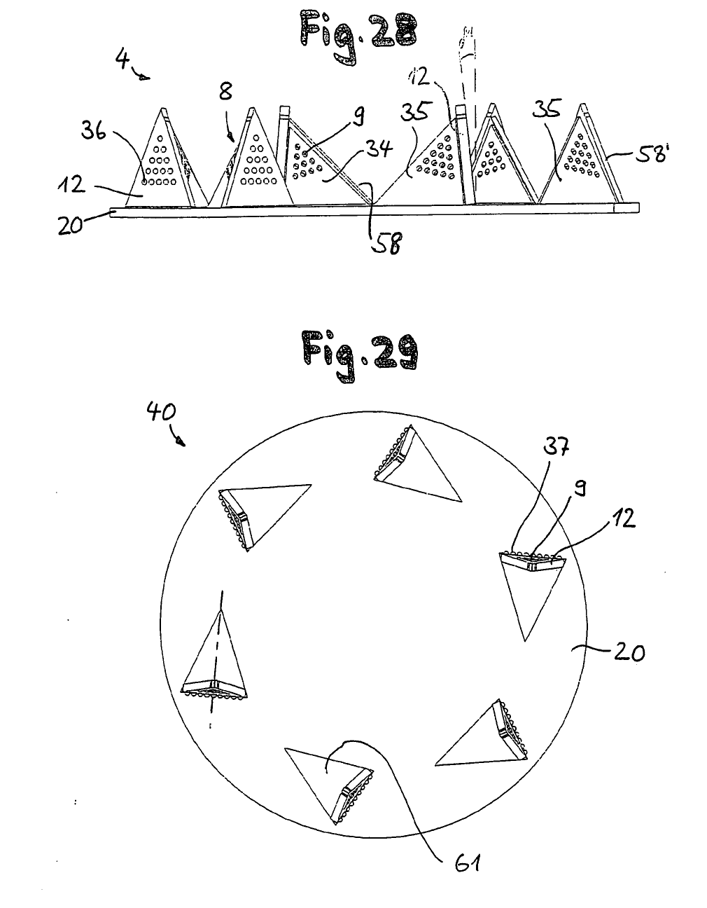

FIG. 30: shows an enlarged illustration of an individual perforation element for the injector plate (detail F according to FIG. 26),

FIG. 31: shows the perforation element according to FIG. 30, but without one of the surface sections,

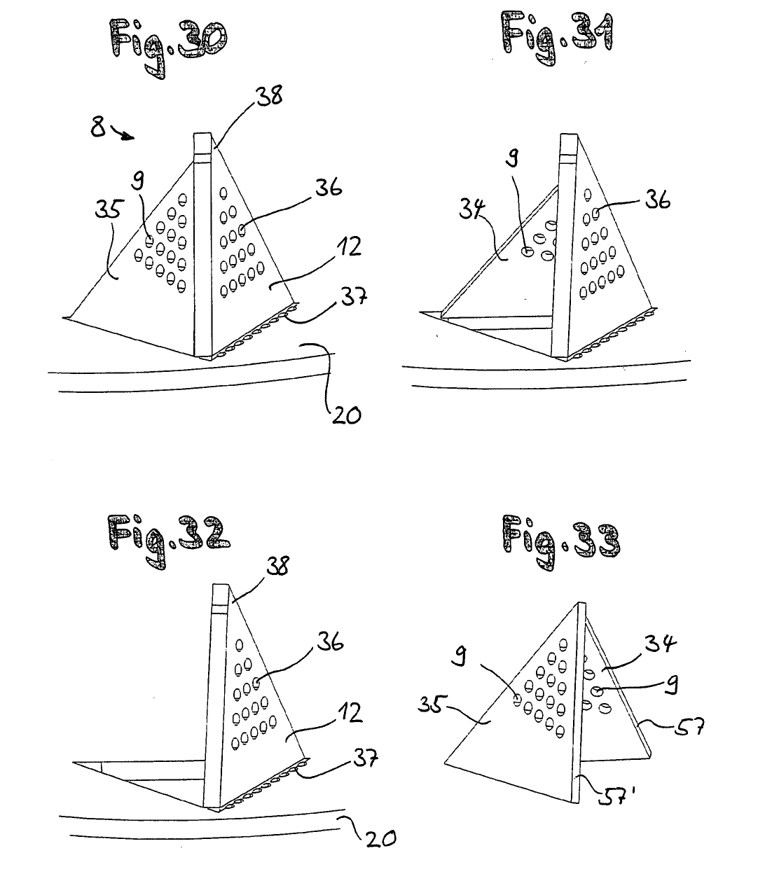

FIG. 32: shows the perforation element according to FIG. 30 without surface sections,

FIG. 33: shows the surface sections for the perforation element according to FIG. 30,

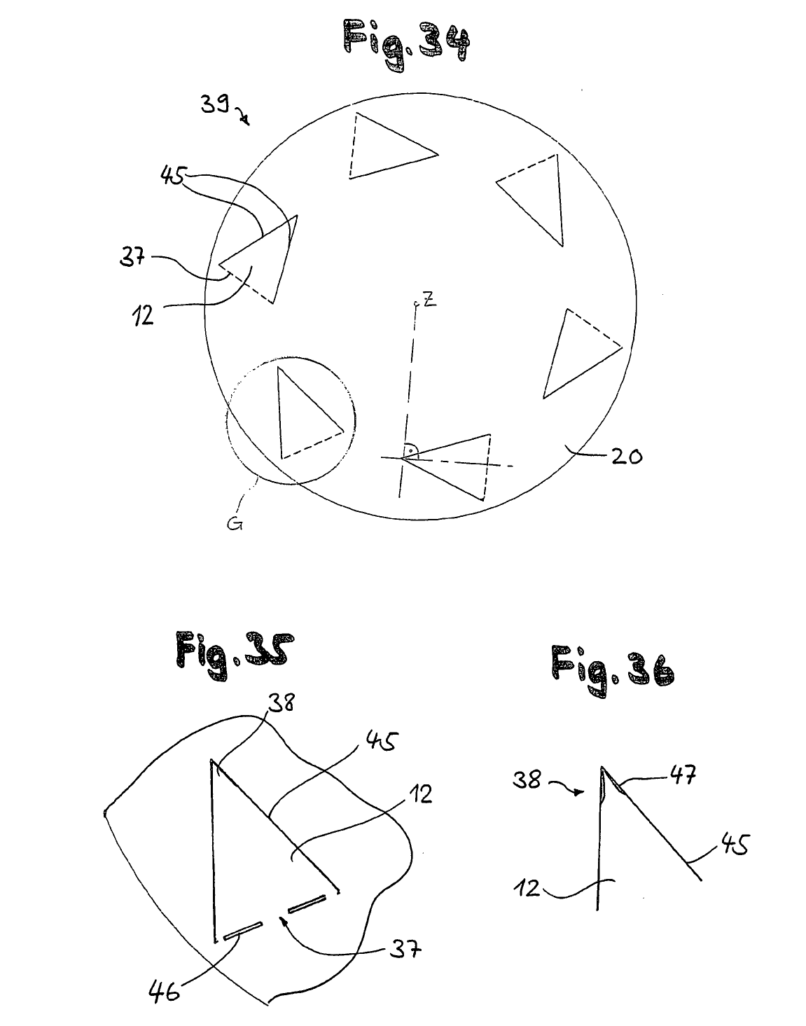

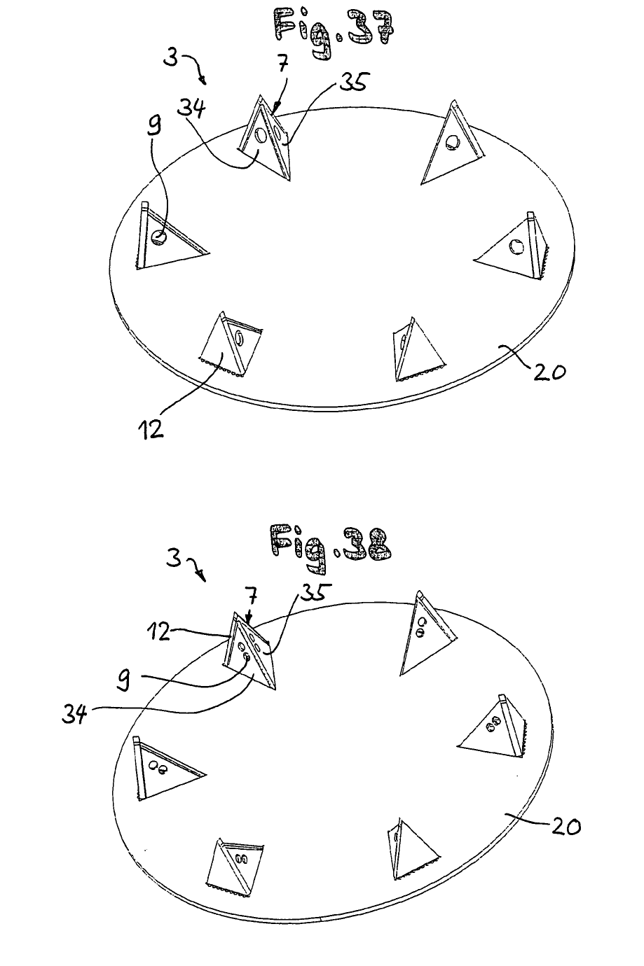

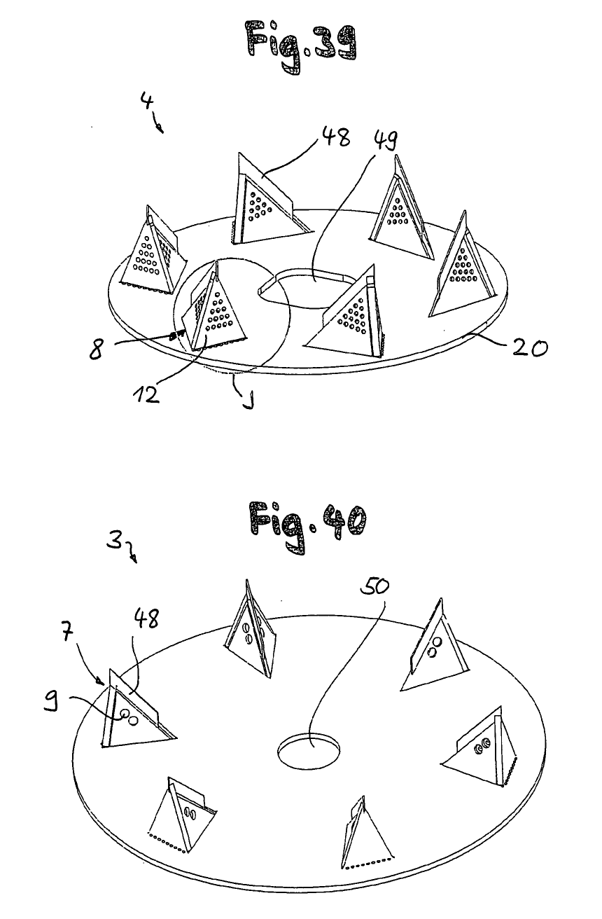

FIG. 34: shows a simplified illustration of a blank for the basic component according to FIG. 29,

FIG. 35: shows an enlarged illustration of a detail of a basic body in a sheet-like position (detail G),

FIG. 36: shows a point of the basic body in a further enlarged illustration,

FIG. 37: shows an enlarged illustration of an injector plate of the device according to FIG. 24,

FIG. 38: shows an alternative injector plate,

FIG. 39: shows a perspective illustration of a further filter plate,

FIG. 40: shows a further injector plate,

FIG. 41: shows a view of a detail of a raised basic body for the filter plate according to FIG. 39,

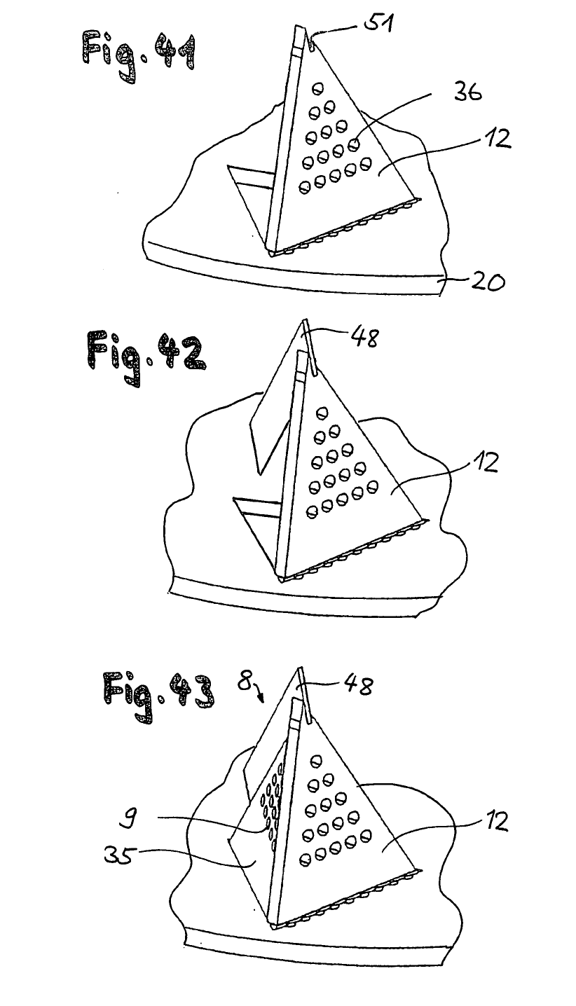

FIG. 42: shows a view of the perforation element according to FIG. 39 without surface sections,

FIG. 43: shows a completely assembled perforation element (detail J according to FIG. 39),

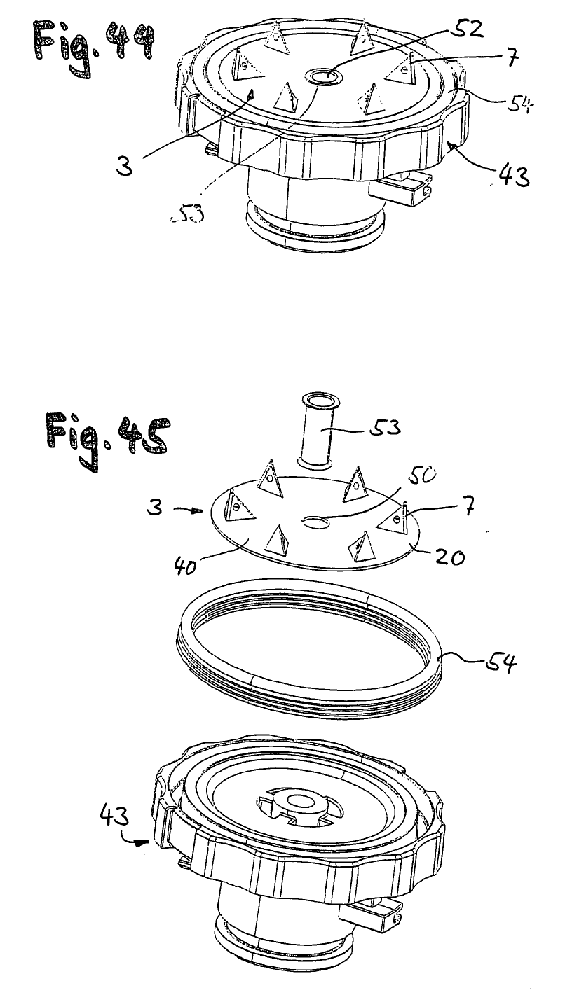

FIG. 44: shows a perspective illustration of a connecting part for the device according to FIG. 24 with an injector plate,

FIG. 45: shows the component according to FIG. 44 in a perspective illustration,

FIG. 46: shows a perspective view of a cutout of a further blank for a basic component,

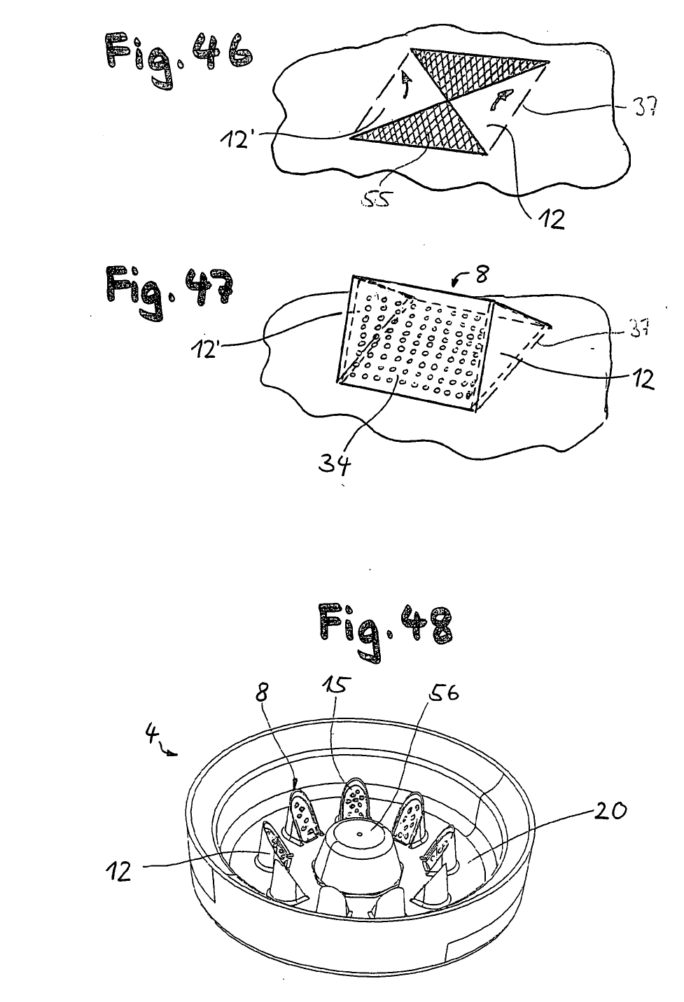

FIG. 47: shows a perspective illustration of a perforation element with a basic part produced from the blank according to FIG. 46 and with surface sections fastened to said basic component,

FIG. 48: shows a perspective illustration of a bottom part with a filter plate inserted therein according to a further embodiment,

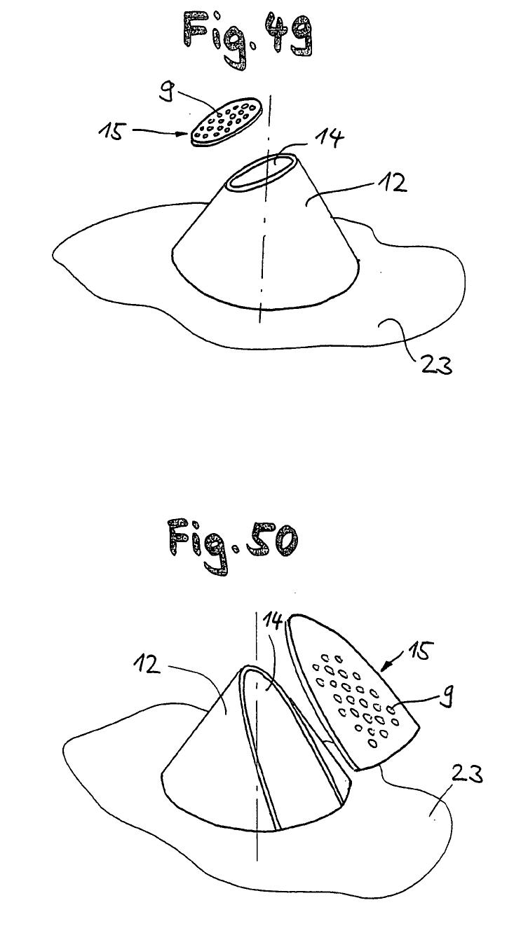

FIG. 49: shows a perspective and enlarged illustration of a further perforation element with a surface section which is not yet fastened,

FIG. 50: shows a further alternative configuration of a perforation element,

FIG. 51: shows a perspective illustration of a basic component and of an individual perforation element for a filter plate,

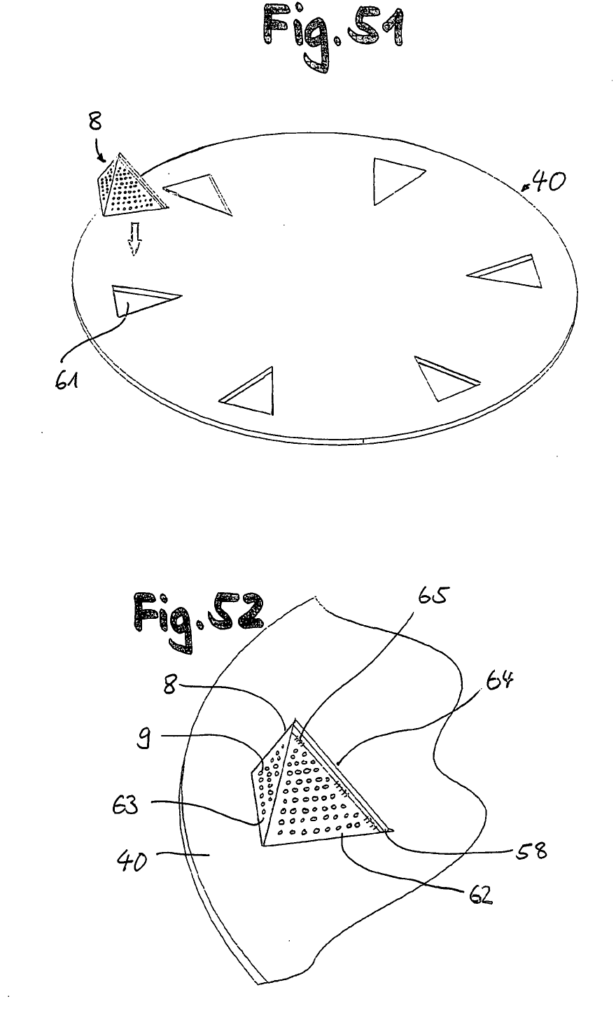

FIG. 52: shows a detailed illustration of a perforation element, which is fastened on the basic component, of the exemplary embodiment according to FIG. 51,

FIG. 53: shows a perspective illustration of a perforation element during a welding operation to stabilize the raised position,

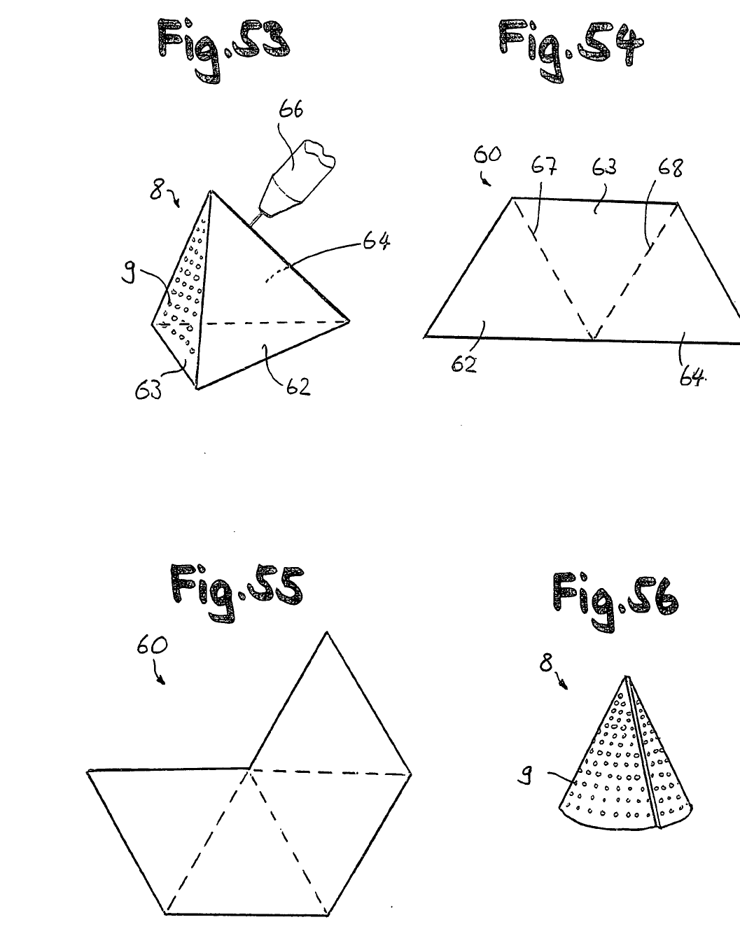

FIG. 54: shows a blank for the perforation element according to FIG. 53,

FIG. 55: shows a blank for a further perforation element, and

FIG. 56: shows a further configuration of a perforation element.

FIG. 1 shows a device, denoted by 1, for extracting an extraction product contained in a capsule 2. This device can be installed as a module in a coffee machine. The device is suitable not only for brewing coffee, but also for tea or cocoa. Of course, the device and the means described below are not restricted to the use in brewing devices of this type for producing beverages. Furthermore, instead of capsules, other portion packagings, for example “sachets” or “pouches”, could also be used. Also conceivable would be use for chemical/scientific extraction implements, for example for extracting samples which have previously been encapsulated or encased in another manner for preservation purposes.

The device 1 has two chamber parts which can be pressed against each other in a sealing manner to form an extraction chamber. In this case, the first chamber part is a closure part 6 to which a pressure line 17 is connected. The front end of the closure part 6 is formed by an injector plate 3 via which heated water can be injected under pressure into the capsule 2. A heating device (not illustrated specifically) ensures the required water temperature and a pump ensures the required water pressure. On the opposite side, a capsule holder 5 with a cavity 16 for receiving the capsule is arranged as the second chamber part. A filter plate 4 with which the capsule 2 can be penetrated and via which the extract can be conducted out of the capsule is arranged on the bottom of the cavity 16. The finished coffee flows via a spout 18 into a provided cup (not illustrated). The basic principle of extraction chambers of this type for capsules has been known and customary for a relatively long time. A comparable extraction chamber has been disclosed, for example, by EP 1 500 357 or from EP 1 295 554. The casing of the capsule is a foil of plastic, of metal or of a laminate.

In the present exemplary embodiment, the capsule holder 5 is mounted in a horizontally displaceable manner and can be displaced in the direction of the closure part 6 via a pivotably mounted actuating lever 19 in order to produce the extraction chamber. The capsule 2 is situated in a horizontal starting position by means of an auxiliary device (not denoted specifically) for holding the capsule 2. In the closing operation, the capsule 2 is received from this position by the cavity 16 by displacement of the capsule holder 5. For the present invention, it is insignificant whether the capsule is inserted horizontally or vertically into a corresponding brewing module. The function of the penetration means is basically provided irrespective of the configuration of the closing mechanism.

Details of the device can be readily seen from FIGS. 2 and 3. As can be seen, means for penetrating the capsule 2 are arranged both on the closure part 6 and on the bottom of the capsule holder, these means 3 and 4, however, being configured differently. The penetration means denoted by 3 conducts the heated water into the capsule 2 while, with the aid of the penetration means 4, the extract is removed from the capsule 2. The penetration means 3 is therefore referred to below as the injector plate and the penetration means 4 is referred to below as the filter plate.

As can be seen, the injector plate 3 has perforation elements 7 which can perforate or pierce the cover foil (not illustrated here) of the capsule 2. Penetration elements 8 are also arranged on the filter plate 4. In the closure position shown in FIG. 3, it can be seen that the penetration bodies 7 have pierced the cover foil and the penetration bodies 8 have pierced the bottom surface of the capsule 2. In this position, a fluid for extracting the extraction product contained in the capsule 2 can be passed through the respective penetration means.

As FIG. 4 shows, the injector plate 3 comprises nine perforation elements 7 which are arranged on a disc body 20. As can be seen, the disc body 20 is of rotationally symmetrical design.

From the sectional illustration according to FIG. 5, it is apparent that the perforation element 7 has the form of a cone trimmed in a sloping manner. The circumferential surface of the cone tapers relatively acutely in the perforation direction, with the angle of inclination γ of the circumferential surface being approximately 5° with respect to the perforation angle. The section of the cone forms the pass-through surface 10 provided with openings 9. It is clearly apparent from FIG. 5 that the pass-through surface runs less steeply with respect to the perforation direction than the circumferential surface of the cone. In the present exemplary embodiment, the angle of inclination β with respect to the perforation direction is approx. 56°. A pass-through surface 10 inclined in such a manner makes an advantageous injection of heated water into the capsule possible. A further advantage of an arrangement of this type is that, for example, a laser for drilling the holes can be positioned in a simple manner. Furthermore, it can be seen from FIG. 5 that the pass-through surface 10 does not have an entirely flat profile but rather is of slightly concave configuration. This curvature has a cylindrically curved profile here. The section of the conical shaped body is predetermined by a cylinder, the cylinder axis of which runs at a right angle to the perforation direction.

FIG. 5 furthermore shows that the perforation element 7 is a projection which protrudes with respect to the upper supporting side 23 for supporting the capsule and is designed as a hollow body. The injector plate 3 could be produced by a deforming process, for example in a deep-drawing technique. After the deep-drawing, the openings 9 are provided by laser drilling. The component 7 preferably comprises a metal sheet of stainless steel. On account of the relatively complicated shaping, it has proven advantageous if the component is formed with the aid of an MIM process or an electro-erosion process. Of course, the perforation element could also be designed as a solid body—instead of as a hollow body, in which case the opening would be formed by a passage, which opens into the pass-through surface, through the solid body.

FIGS. 6 and 7 show alternative configurations of points. The perforation element 7 according to FIG. 6 has a conical basic shape. As can be seen, the angle of inclination γ of the circumferential surface 21 is significantly larger here than in the preceding exemplary embodiment. Furthermore, the pass-through surface 10 is of relatively small design. As emerges from FIG. 7, the shaped body for the perforation element does not absolutely have to be based on a cone. In FIG. 7, the shaped body is a pyramid with a rectangular base area which is trimmed in a sloping manner to form the pass-through surface 10. As can be seen, the pyramid side surfaces 22 likewise form an acute angle γ with respect to the perforation direction.

FIG. 8 shows that the individual perforation elements 9 are arranged in a uniformly distributed manner in a circle around the centre of the disc body 20. From the detailed illustration in FIG. 9 of an individual perforation element 7, it can be seen that the openings 9 form a strainer structure. In this case, the opening 9 is a round hole in each case. Of course, however, other hole shapes would also be conceivable. The strainer structure is a perforated area with openings 9 arranged in rows, the rows being offset at 60° with respect to one another (α=60°). However, the rows could also be arranged in a diagonally offset manner (a would then be 45°). Of course, it would also be conceivable to provide rectilinear rows of openings.

The diameter d of the round holes may be between 0.2 and 0.5 mm (for example, 0.25 mm). The separation between the holes, which may be between 0.3 and 1.0 mm (for example t=0.45 mm) is denoted by t. It is generally advantageous if the web width b (b=t−d) is smaller than the diameter d of the round holes.

FIG. 10 shows the filter plate 4 in a cross-sectional illustration. A relatively large number of relatively small openings 9 (compared with the pass-through surface of the injector, cf., for example, FIG. 9) can be clearly seen on the pass-through surface 11 of the perforation element 8. This is necessary because the pass-through surface 11 is to have a filtering effect. For example, when coffee is extracted, the extract has to be filtered.

The pass through surface 11 which is provided with the openings 9 is arranged in a surface section 15 which is fastened to the individual perforation elements 8. The filter plate 4 therefore comprises a base plate 25 and a foil or blank 13 containing the surface sections 15. This two-part construction of the filter plate is apparent from FIG. 11. The foil, which is denoted by 13, with the surface sections 15, which are referred to as foil sections below, serves essentially for filtering the extract out of the capsule. The base plate 25 with the basic bodies 12, which predetermine the shape of the perforation elements, essentially has the task of piercing or perforating the capsule (i.e. the bottom surface of the capsule). The foil 13 is placed onto the base plate 25 (indicated by arrow) and can then be welded to the base plate 25. Of course, however, other fastening possibilities (for example adhesive bonding) would also be conceivable. The thickness of the steel foil is between 0.05 and 0.1 mm. Other foil thicknesses are also conceivable depending on the intended purpose.

As emerges from FIG. 12, the base plate which is provided as the basic component is of rotationally symmetrical design and has a disc-shaped configuration. Nine basic bodies 12 which are designed as projections protruding with respect to the flat upper supporting side 24 are formed on the base plate. Nine outlets 26 are correspondingly arranged on the rear side of the base plate 25, as FIG. 13 shows.

As in particular FIG. 14 clearly shows, the basic body 12 is of wedge-shaped design. The wedge shape produces a front edge 29 with a cutting edge 30. The wedge surface facing the centre of the base plate is inclined by an angle ε with respect to the perforation direction. This angle of inclination E can be between 10° and 30° (for example here: approx. 23°). The side surface of the basic body 12 runs at an acute angle in the perforation direction, with γ preferably being smaller than 10° (here: γ=5°). The basic body 12 is designed as an open hollow body, with the front, open end being surrounded by the edge 29. Set back behind the edge 29 is an encircling shoulder 28 which serves as a contact surface for the foil section (the foil section therefore has for this an edge region which is free from holes, cf. FIG. 18). The shoulder 28 therefore predetermines the pass-through surface. The shoulder 28 is inclined by an angle β with respect to the perforation direction that is larger than the angle of inclination of the wedge surface (β>ε). The perforation and filtering properties of the perforation element can thereby be optimized. Here, i.e. in the present exemplary embodiment, the angle of inclination β is approx. 40°.

FIG. 15 shows that the basic bodies 12 are arranged in a uniformly distributed manner in a circle around the base plate 25. FIG. 16 and FIG. 17 show an associated blank, which is denoted by 13, for the foil which can be fastened onto the base plate.

As FIG. 18 reveals, the openings 9 on the foil section are arranged in a strainer structure. The openings 9, which are designed as round holes, have a diameter d of between 0.1 and 0.3 mm (for example, here: 0.17 mm for coffee). However, the hole size depends on the extraction product and on the desired extraction quality and can be adapted as desired. The web width b is smaller than the diameter d of the holes 9. The distance between the rows, which is 0.25 mm here, is denoted by a. The rows are offset diagonally here.

The capsule 2 illustrated in FIG. 19 has, on the bottom, a bottom section 31 which is set back and which is of trough-like design in cross section. This bottom section is designed as an inwardly directed depression 31 encircling in an annular manner and is referred to below as the pre-brewing channel. This pre-brewing channel 31 can be seen particularly readily from the detailed illustration according to FIG. 21. A set-back (but not in the manner of a channel) bottom section can likewise be seen from FIG. 2. The inwardly offset bottom section here is a single trough 31.

During closure of the extraction chamber, the bottom surface of the capsule 2 is pressed against the filter plate 4, which is provided with perforation elements 7 (illustrated without foil) and, in the process, is perforated in the region of the pre-brewing channel 31. A perforated trough 31 of a capsule 2 in the closed position (or pre-brewing position) is shown in FIG. 22. As can be seen, the cavity 16 is larger than the capsule and can be used to absorb the expansion of the capsule during the extraction operation (this applies particularly to capsules made of plastic or a laminate). In particular, the capsule bottom is spaced apart from the upper supporting side in the closed position before the brewing operation. This distance a may be, for example, between 0.5 and 1.0 mm. The distance and the pre-brewing channel 31 result in there only being a partial perforation of the capsule bottom before the brewing operation, as a result of which the pass-through surface is only slightly opened up. As soon as brewing water penetrates through the penetrated capsule under pressure, a pressure builds up in the interior of the capsule, in which case the capsule bottom is also pressed against the upper supporting side 24 of the filter plate 4. Subsequently, the capsule casing also expands as a consequence of the increase in temperature. FIG. 23 shows the capsule 2 subjected to such a brewing pressure. As can be seen, the capsule bottom has been deformed as a consequence of the brewing pressure in such a manner that it rests on the upper supporting side 24 in a sheet-like manner. After the capsule bottom 32 has therefore also been completely perforated, the beverage flows out using the virtually completely opened-up area of the pass-through surface. In addition, by means of a deformation of the pre-brewing channel, the perforation elements are sealed at their base by the capsule casing which is displaced downwards onto the filter plate. As can be seen, this sealing effect is obtained by the tabs 31, 31′ of the capsule bottom, which tabs bear against the perforation element. Tests have surprisingly shown that a significantly better sealing effect can be achieved with a channel arrangement in comparison with a trough arrangement (cf. capsule according to FIG. 2).

FIGS. 24 and 25 show a further possible configuration of the device 1. The device 1 differs from the device according to FIG. 1 by a slightly differently designed closing mechanism which can be actuated via the actuating lever 19. The penetration means 3 and 4, which are described in more detail below, each have a plurality of pyramid-shaped perforation elements 7 and 8. As is furthermore revealed in FIGS. 24 and 25, the device 1 is designed for a different capsule 2. The bottom of the capsule 2 has a channel which forms a zone which can be penetrated by the perforation elements 8. These or comparable capsules are described in European Patent Application No. 07100520.1. With regard to further structural details for the capsule, reference is therefore made to the European patent application mentioned which hereby expressly forms part of the disclosure of this application. It can then be seen, for example from FIG. 24, that an annular receiving trough 42 corresponding to the perforation elements 8 is arranged on the bottom of the cavity, said receiving trough forming an annular gap between the filter plate 4 and the bottom of the cavity.

FIG. 26 shows a simplified illustration of a filter plate 4 for the device according to FIGS. 24/25 (it is simplified because a central hole for a fastening screw 41 is absent here, see FIG. 24; but compare FIG. 39). The means 4 has six perforation elements 8 which each have a pyramid-like configuration. In this case, a perforation element 8 comprises the basic body 12 and two surface sections 34 and 35 fastened thereto. Said surface sections 34 and 35 form pass-through surfaces on which a plurality of openings 9 are arranged. Said openings 9 form a strainer structure in the form of a perforated area. Such perforated area arrangements have already been described in the previous exemplary embodiments. The dimensions thereof could also be used for the pass-through surfaces of the present perforation elements 8. However, it has been shown, in conjunction with the present, specially designed perforation elements 8, that hole sizes of 0.1 to 0.3 mm can be particularly advantageous. In contrast, for example, to the filter plate according to FIG. 10, openings are not only arranged on the surface sections but also on the basic body 12. The basic body 12 is a sheet-like part which is connected integrally to the base plate 20. The precise construction of the penetration means is described in precise terms below with reference to FIGS. 27, 29 to 33.

It emerges from the illustration according to FIG. 27 that the penetration means 4 is constructed from at least two separate components. It firstly comprises a basic component 40 with the basic bodies 12 and secondly surface sections 34 and 35. The two surface sections adjoin each other on the border side at an acute angle. This produces a roof-like construction, wherein, as FIG. 27 shows, the two sections 34 and 35 are connected to each other in a pre-manufactured state. As FIG. 27 and in particular FIG. 33 shows, the surface section 34 is offset slightly inwards in relation to a corresponding side border of the surface section 35, thus resulting in a cutting edge. Furthermore, surface section side borders which are denoted by 57 and 57′ and are provided for bearing against an inner surface of a respective basic body can be seen in FIG. 33. As the present exemplary embodiment shows, not only the surface sections, but also the basic bodies 12, have pass-through surfaces with corresponding openings 9. The corresponding openings in the basic body 12 are denoted by 36.

From FIG. 28, it can be gathered, for example, that the basic body 12 is oriented at an acute angle γ in relation to the perforation direction. Advantageous perforation results can be obtained by said very steep arrangement of the basic body 12. In the present case, the angle of inclination β is approx. 5°. Furthermore, it can readily be seen here that the surface sections 34 and 35 are each offset inwards in relation to a corresponding border 58 and 58′ of the basic body 12 in order to form a cutting edge.

It is revealed in FIG. 29 and FIG. 32 that the basic body 12, which is designed as a sheet-like part, is raised from a sheet-like position into the end position shown. The basic body 12 can be produced from a blank, with a triangular hole 61 corresponding to the shape of the basic body being produced in the disc body 20 during the raising operation. The associated blank is illustrated in FIG. 34. The blank 39 has two cutting lines 45 which converge with each other at an acute angle. The ends of the cutting lines 45 are connected to each other by a line 37 (illustrated by dashed lines) which predetermines a bending or folding line for the raising operation. The position of the individual triangles in the blank is furthermore apparent in FIG. 34 by means of auxiliary lines (the axis of symmetry runs approximately at right angles to the connecting line between the centre Z and point of the triangle).

For a defined raising operation, it may be advantageous if the blank has corresponding lines of weakness for predetermining bending and folding lines. One possible configuration of a line of weakness of this type is shown in FIG. 35. It can be seen here that the line of weakness 37 is formed by two cutting line portions 46 of limited design. Said cuts can be produced, for example, by means of lasers. The points of the triangles are in each case illustrated in a simplified form in FIGS. 34 and 35. As emerges, however, in FIG. 36, a further sharpening of the point 38 can be achieved by means of undercuts 47. Of course, it would, however, basically also be conceivable to design the basic body as a component which is separate from the disc body.

The respective surfaces of the basic body 12 and of the surface sections 34 and 35 are of planar or approximately planar design. Of course, however, in principle, convex or concave configurations of the individual surfaces or of all of said surfaces would also be conceivable. The thickness of the basic body 12 and therefore also of the disc body 20 can also be, for example, 0.4 mm. The surface sections 34 and 35 fastened to the basic body can be configured to be thinner, with a material thickness of 0.2 mm having proven advantageous with regard to producibility, on the one hand, and stability, on the other hand.

FIGS. 37 and 38 show two configurations of injector plates. Analogously to the exemplary embodiment according to FIG. 26, the perforation elements 7 firstly comprise a basic body 12 and secondly comprise two surface sections 34 and 35 fastened thereto. Differences reside in particular in the fact that openings in perforation elements 7 for the passing through of fluid are provided here only in the surface sections. The surface sections 34 and 35 according to FIG. 37 thus each have a relatively large opening 9 (the possible diameter ranges between 0.2 mm and 2 mm). In the exemplary embodiment according to FIG. 38, two openings 9 with correspondingly smaller diameters are arranged in each case in the surface sections 34 and 35. Furthermore, the penetration means differ from the abovementioned exemplary embodiment in that the respective perforation elements 7 are oriented towards the centre of the disc body.

FIGS. 39 and 40 show further modifications of penetration means. In order to optimize the perforation, the perforation elements 7 and 8 are equipped with blade elements 48 which serve to cut through the casing of the portion packaging for the first time in order to initiate a piercing operation. Blade elements of this type may be advantageous in particular when using polypropylene capsules. A central hole 49 for the screw connection can furthermore be seen in FIG. 39 (cf. FIG. 24). The injector plate 3 according to FIG. 40 also has a central hole 50 (cf. FIGS. 44 and 45 below).

As revealed in FIGS. 41 to 43, the basic body 12 has, in the region of its point, a slot 51 for receiving the blade element (FIG. 41). A blade element 48 which is inserted into the slot can be welded to the basic body 12 and/or to the surface sections of the perforation element 8.

FIG. 44 shows a connecting part 43 (cf. FIG. 24) which can be fitted into the extraction device and in which the injector plate 3 or the basic component 40 of the injector plate is held by means of a central clamping sleeve 53. Furthermore, an annular seal 54 which surrounds the disc body of the filter plate is also arranged in the connecting element 43. The connecting element 43 has means for connection to the device in the form of a bayonet fastening. The individual components are shown once again in FIG. 45.

As FIG. 47 shows, a perforation element can also have a plurality of basic bodies. In the present case, the perforation element 8 has two triangular basic bodies 12 and 12′ which are spaced apart from each other. The distance between the basic bodies 12, 12′ is bridged by the surface section 34 which, as the pass-through surface, is provided with a multiplicity of openings. One possible blank for said perforation element is shown in FIG. 46. The triangular surfaces for the basic bodies 12 and 12′ are predetermined firstly by corresponding bending lines 37 and secondly by mutually opposite, triangular cutouts 55 identified specifically by hatching.

FIG. 48 shows a further possible configuration of a penetration means. The basic shape of the basic bodies 12 is of virtually cylindrical design. However, the cylinder is cut, with a full section 15 having openings being fastened as the pass-through surface to the basic body in a manner slightly offset back from the cut surface. A central elevation 56 of approximately frustoconical shape can furthermore be seen, said elevation being of approximately complementary design to a corresponding bottom of a capsule (cf. FIG. 24).

As FIGS. 49 and 50 show, the basic bodies 12 can be of conical design, with it being possible for the cone to be cut in such a mariner that an elliptical section (FIG. 49) or a parabolic section (FIG. 50) is produced. The respective hollow body openings 14 can be covered by corresponding surface sections 15.

FIG. 51 shows, in an exploded illustration, two components for a filter plate. The filter plate comprises a disc-shaped basic component 40 in which six triangular holes 61 are arranged. In a manner corresponding to the holes 61, perforation elements 8 are fastened to the basic component 40 by welding. In contrast, for example, to the exemplary embodiment according to FIG. 26, a penetration means which manages without basic bodies is therefore produced. The precise construction of this special perforation element 8 is described in detail below with reference to FIGS. 52 to 54.

The perforation element comprises three surface sections 62, 63 and 64 which are interconnected and are assembled in the manner of a pyramid, with the pyramid shape being stabilized by a welded joint. Three fillet welds which are indicated by 65 and to which the surface section 64 bearing against the inner surface of the surface section 62 is connected can be seen in FIG. 52. The surface section 62 is obviously offset inwards in relation to the border 58 of the surface section 64, as a result of which an advantageous cutting edge is formed. The respective surface sections are provided with a multiplicity of openings 9. With regard to the strainer structure of the openings, reference is made to the previous explanations which basically also apply to this exemplary embodiment.

In FIG. 53, the perforation element 8 is designed as a tetrahedron. In contrast to the perforation element according to FIG. 52, the surface sections 62 and 64 form a common side edge. In order to stabilize the tetrahedron, the surface sections 62 and 64 are connected to each other, for example by laser welding. A corresponding welding unit is shown by 66 in FIG. 53. Furthermore, it is revealed in FIG. 53 that not absolutely all of the surface sections have to be provided with openings 9. Of course, the perforation element could also be used for an injector plate. It would then even be conceivable to form a perforation element of this type without openings. In this case, the openings for the passing through of the fluid could be arranged, for example, in the disc-shaped base plate.

FIG. 54 shows a blank 60 for the perforation element according to FIG. 53. The blank 60 comprises the three surface sections 62, 63 and 64 which are each separated from one another by lines of weakness 67 and 68. The lines of weakness 67 and 68 facilitate a defined folding over of the respective surface sections during a raising operation in order to produce the end position of the perforation element. Analogously to the exemplary embodiment according to FIG. 35, the lines of weakness may comprise limited cutting line portions extending along the lines. In said sheet-like position, openings in the desired configuration can be provided in a simple manner on such a blank 60, for example by laser drilling processes. The blank 60 advantageously comprises a foil or a thin metal sheet, in particular of steel. The thickness of the foil or of the sheet can be between 0.2 and 0.5 mm.

FIG. 55 shows a further blank for a perforation element, in which an additional surface section is attached in comparison to FIG. 54. A perforation element in the form of a pyramid with a square area can be raised by means of said blank 60.

As revealed in FIG. 56, the perforation elements comprising a sheet-like material do not absolutely have to be of multi-surface design. FIG. 56 shows a corresponding perforation element 8 which is designed as a cone. The cone is formed from a correspondingly shaped, sheet-like blank, with the two ends being connected to each other in an overlapping manner, as a result of which the cone shown in FIG. 56 can be raised.

1-42. (canceled)

43. Means for penetrating a portion packaging (2) containing an extraction product, in particular a capsule, with at least one perforation element (7, 8) with which a casing of the portion packaging (2) can be pierced in a perforation direction, the perforation element (7, 8) having a plurality of openings (9) through which a fluid can be passed, characterized in that the perforation element (7, 8) is designed as a multi-surface body, with at least one of the surfaces being a surface (10, 11, 34, 35, 62, 63, 64) which is inclined in the perforation direction and on which the openings (9) are arranged preferably in a strainer structure.

44. Means according to claim 43, characterized in that at least one of the surfaces (10, 11, 34, 35, 62, 63, 64) on which openings (9) are arranged in a strainer structure is a planar or concavely curved surface.

45. Means according to claim 43, characterized in that a pass-through surface (10, 11) which is provided with openings (9) in a strainer structure is or forms a wedge surface which is preferably directed towards the centre of the means.

46. Means according to claim 43, characterized in that the openings (9) are each round holes, with the diameter (d) of the round holes being between 0.1 and 0.5 mm and preferably between 0.2 and 0.3 mm.

47. Means according to claim 43, characterized in that the at least one perforation element (7, 8) is designed as a pyramid with a preferably triangular basic surface, with at least one of the side surfaces (34, 35, 62, 63, 64) of the pyramid having openings (9) in a strainer structure, or in that the multi-surface body for the at least one perforation element (7) is designed as a trimmed shaped body, in particular as a trimmed cone, as a trimmed pyramid or as a trimmed wedge, and in that a pass-through surface (10, 11) which is provided with openings (9) in a strainer structure is predetermined by the preferably sloping section.

48. Means according to claim 43, characterized in that it has a preferably disc-shaped basic component (20, 40) with an upper supporting side (23, 24) for supporting the portion packaging (2), and in that the at least one perforation element (7, 8) is designed as a separate component in relation to the basic component (20, 40).

49. Means according to claim 43, characterized in that it has a plurality of perforation elements (7, 8).

50. Means according to claim 43, characterized in that the perforation element (7, 8) is at least partially composed of a sheet-like material, in particular of a foil or a metal sheet.

51. Means according to claim 50, characterized in that the perforation element (7, 8) is formed from at least one blank (60) which is raised from a sheet-like position into an end position, with the raised blank in the end position entirely or partially predetermining the shape of the perforation element (7, 8).

52. Means according to claim 50, characterized in that the perforation element (7, 8) is formed from a single blank (60).

53. Means according to claim 51, characterized in that the raised blank is stabilized in the end position by means of a welded joint.

54. Means according to claim 50, characterized in that the perforation element (7, 8) contains at least two abutting surface sections (62, 63, 64) forming a common side edge, with the surface sections (62, 63, 64) being folded around the side edge (67, 68).

55. Means according to claim 54, characterized in that, in order to predetermine the side edge in the blank (60), there is a line of weakness (67, 68), in particular a line of weakness with section line portions which extend to a limited extent in the direction of the line of weakness and about which the surface sections (62, 63, 64) can be folded over.

56. Means according to claim 50, characterized in that the blank (60) has at least three, in each case triangular surface sections (62, 63, 64), the blank (60), by folding over of the surface sections (62, 63, 64), being raisable from the sheet-like position in such a manner that a pyramid-like hollow body is present in the end position.

57. Means according to claim 48, characterized in that the perforation element (7, 8) is welded onto the basic component (20, 40).

58. Means according to claim 43, characterized in that a blade element (48) for cutting through the casing of the portion packaging (2) for the first time in order to initiate the piercing operation is attached to at least one surface section (34, 35).

59. Means according to claim 48, characterized in that it furthermore has at least one central opening (52) in the basic component (40) for the additional and/or alternative conducting of fluid into or out of a portion packaging (2) perforated by the at least one perforation element (8).

60. Means according to claim 59, characterized in that the basic component (40) is connected via a central clamping sleeve (53) to a connecting part (43) which can be fitted into an extraction device (1), the clamping sleeve forming the central opening (52).

61. Device for extracting an extraction product contained in a portion packaging, in particular in a capsule (2), with a liquid extractant, the device containing two chamber parts which can be pressed against each other to form an extraction chamber, one chamber part being designed as a capsule holder (5) with a cavity (16) for receiving the capsule (2) and the other chamber part being designed as a closure part (6) for closing the cavity, and at least one of the chamber parts, preferably each chamber part, being assigned means (3, 4) for penetrating the capsule and for passing the extractant through the closed extraction chamber according to claim 43.

62. Device according to claim 61, characterized in that at least one of the means (3, 4) is screwed to the device (1).
